(19) United States
(12) Patent Application Publication
(10) Pub. No.: US 2011/0063564 A1
(43) Pub. Date: Mar. 17, 2011

(54) LIQUID CRYSTAL COMPOSITE, CELL, DEVICE, AND METHOD THEREOF

(75) Inventors: Hari Mukunda Atkuri, Kent, OH (US); Ke Zhang, Stow, OH (US); John L. West, Hartville, OH (US); Anatoliy Glushchenko, Colorado Springs, CO (US)

(73) Assignees: Kent State University; The Regents of the University of Colorado, A body Corporate

(21) Appl. No.: 12/557,733

(22) Filed: Sep. 11, 2009

(51) Int. Cl. C09K 19/02; C09K 19/54

(52) U.S. Cl. 349/182; 252/299.5

(57) ABSTRACT

The invention provides a liquid crystal (LC) composite, a LC cell, a LC device, and a method thereof. The LC composite comprises (i) a liquid crystal material, and (ii) a copolymer polymerized from LC monomers and non-LC-monomers; and the LC composite is mechanically stressed/sheared. The invention exhibits numerous merits such as high transmittance in visible and IR range, hysteresis free, and a simple fabrication process; and may be utilized in LC device applications such as adaptive optics e.g. beam steering devices and fast tip-tilt wavefront correctors; and general optical applications such as eye wears, compact cameras and compact telescopes.

### BACKGROUND OF THE INVENTION

The present invention relates to a liquid crystal (LC) composite, a cell, a device, and a method thereof. It finds particular application in conjunction with high transmittance stressed liquid crystals in the visible spectrum for applications such as adaptive optics e.g. tip-tilt correctors; and in general applications such as eye glasses, compact cameras, compact telescopes, and any other applications requiring changes in the optics of the device; and will be described with particular reference thereto. However, it will be appreciated that the invention is also amenable to other like applications.

This invention was made with government support under contract FA7014-07-C-0013 from the U. S. Air Force. The government has certain rights in this invention.

During the search for an ideal fast-switching large phase modulation material, John L. West et al. at Kent State University, Ohio, have found interesting light modulating properties from a sheared liquid crystal/polymer composite. As disclosed in “Polymer Dispersed Liquid Crystals for Fast Electrically Controlled Phase Retarder,” Polymer Preprints 43 (2), 532-533 (2002), the sheared sample can modulate large phase retardation at fast speeds. They are much different from PDLCs because of the absence of light scattering in any polarization. This system decouples the speed and liquid crystal film thickness and it is referred to as a stressed liquid crystal (SLC) in “Fast birefringent mode stressed liquid crystal”, Appl. Phys. Lett. 86, 031111 (2005). The SLC fabrication process is outlined in “Description of experimental work”, as described in pages 28-29 in Kent State University Ph.D. Thesis (2007) of Zhang Guoqiang titled “Stressed Liquid Cristals: Properties and applications”.

SLCs have advantages such as i) ultra-large phase modulation with fast speeds (e.g. ˜50micron phase shift can be achieved in 10 ms, 5 microns of phase retardation in sub-milli seconds), ii) large active area, iii) photopatternability, iv) linear voltage response with no hysteresis, v) independent of polarized light and vi) high transmittance in the IR.

However, SLC cells are opaque and show poor transmittance in the visible wavelength range, which limits their applications in glass lenses and optical devices because of the refractive index mismatch between LC and polymer. Also the opaqueness is, as a result of unaligned LC director, present throughout the LC- polymer mixture.

Advantageously, the present invention provides a liquid crystal (LC) composite, cell, device, and method thereof that solve these problems. For example, the invention provides a high transmittance (low light scattering) stressed liquid crystal (HTSLC) formula in the visible spectra exhibiting most of the benefits of a stressed liquid crystal. While SLCs lack high transparency in the visible range, the present invention improves over known SLCs by providing high transparency in the visible light range and therefore making them very promising for display applications as well as for adaptive optics applications requiring this feature.

### BRIEF DESCRIPTION OF THE INVENTION

One aspect of the invention provides a LC composite comprising:

(i) a liquid crystal material, and

(ii) a copolymer polymerized from LC monomers and non-LC monomers;

wherein the LC composite is mechanically stressed/sheared.

Another aspect of the invention provides a LC cell including a LC composite comprising:

(i) a liquid crystal material, and

(ii) a copolymer polymerized from LC monomers and non-LC monomers;

wherein the LC composite is mechanically stressed/sheared.

Still another aspect of the invention provides a LC device built with one or more cells including a LC composite comprising:

(i) a liquid crystal material, and

(ii) a copolymer polymerized from LC monomers and non-LC monomers;

wherein the LC composite is mechanically stressed/sheared.

Still another aspect of the invention provides a method of preparing a LC composite comprising:

(i) providing a mixture comprising a liquid crystal material, LC monomers and non-LC monomers;

(ii) copolymerizing the LC monomers and the non-LC monomers; and

(iii) shearing the mixture with a mechanical force/stress.

A further aspect of the invention provides a method of preparing a LC cell and a LC device comprising:

(i) providing a mixture comprising a liquid crystal material, LC monomers and non-LC monomers;

(ii) copolymerizing the LC monomers and the non-LC monomers;

(iii) placing the mixture between two substrates; and

(iv) shearing the mixture with a mechanical force/stress.

### BRIEF DESCRIPTION OF THE DRAWINGS

FIG. 1-1 shows the schematic diagram of a HTSLC/SLC tip-tilt corrector with an interdigitally patterned ITO bottom substrate and a non patterned ITO top substrate in an embodiment of the invention;

FIG. 1-2 schematically illustrates the basic structure of a tip-tilt corrector in an embodiment of the invention;

FIGS. 2-1, 2-2 and 2-3 illustrate the steps in preparing a liquid crystal cell in an embodiment of the invention;

FIG. 3 shows the SEM morphology of a LC composite comprising 5CB:RM82:NOA65 in the weight ratio of 90:6:4 in an embodiment of the invention;

FIG. 4 shows the SEM morphology of a LC composite comprising 5CB:RM82:NOA65 in the weight ratio of 90:4:6 in an embodiment of the invention;

FIG. 5 shows the transmittance spectrum of a 18 μm high transmittance liquid crystal cell comprising 5CB:RM82:NOA65 in the weight ratio of 90:6:4 in the 400-2000 nm range;

FIG. 6 shows the transmittance spectrum of a 18 μm high transmittance liquid crystal cell comprising 5CB:RM82:NOA65 in the weight ratio of 90:4:6 in the 400-2000 nm range;

FIG. 7 shows the transmittance spectrum of a 18 μm high transmittance liquid crystal cell comprising 5CB:NOA65 in the weight ratio of 90:10 in the 400-2000 nm range;

FIG. 8 shows the transmittance for the 18 μm HTSLC cells comprising different amounts of RM82 in 400 nm -800 nm visible wavelength;

FIG. 9 schematically illustrates the basic structure of a setup for the electro optical measurements of LC cells;

FIG. 10 shows the time response of a 18 μm liquid crystal cell comprising 5CB:RM82:NOA65 in the weight ratio of 90:6:4;

FIG. 11 shows the time response of a 18 μm liquid crystal cell comprising 5CB:RM82:NOA65 in the weight ratio of 90:4:6;

FIG. 12 shows the time responses of the 18 μm liquid crystal cell comprising 5CB:NOA65 in the weight ratio of 90:10 as a control;

FIG. 13 shows the static response of a 18 μm liquid crystal cell comprising 5CB:RM82:NOA65 in the weight ratio of 90:6:4;

FIG. 14 shows the static response of a 18 μm liquid crystal cell comprising 5CB:RM82:NOA65 in the weight ratio of 90:4:6;

FIG. 15 shows the static response of a 18 μm liquid crystal cell comprising 5CB:NOA65 in the weight ratio of 90:10 as a control;

FIG. 16 shows the dependence of the phase retardation of a 18μm HTSLC cell comprising 5CB:RM82:NOA65 in the weight ratio of 90:6:4 as a function of voltage;

FIG. 17 shows the dependence of the phase retardation of a 18 μm HTSLC cell comprising 5CB:RM82:NOA65 in the weight ratio of 90:4:6 as a function of voltage;

FIG. 18 shows the transmittance spectrum of a 18 μm high transmittance liquid crystal cell comprising 5CB:RM82:NOA65 in the weight ratio of 90:2:8 in the 400-800 nm range;

FIG. 19 shows the transmittance spectrum of a 18 μm high transmittance liquid crystal cell comprising 5CB:RM82:NOA65 in the weight ratio of 90:2:8 in the 400-2000 nm range;

FIG. 20 shows the transmittance spectrum of a 18 μm high transmittance liquid crystal cell comprising 5CB:RM82:NOA65 in the weight ratio of 90:8:2 in the 400-800 nm range;

FIG. 21 shows the transmittance spectrum of a 18 μm high transmittance liquid crystal cell comprising 5CB:RM82:NOA65 in the weight ratio of 90:8:2 in the 400-2000 nm range;

FIG. 22 shows the static response of a 18 μm liquid crystal cell comprising 5CB:RM82:NOA65 in the weight ratio of 90:2:8;

FIG. 23 shows the static response of a 18 μm liquid crystal cell comprising 5CB:RM82:NOA65 in the weight ratio of 90:8:2;

FIG. 24 shows the time response of a 18 μm liquid crystal cell comprising 5CB:RM82:NOA65 in the weight ratio of 90:2:8;

FIG. 25 shows the time response of a 18 μm liquid crystal cell comprising 5CB:RM82:NOA65 in the weight ratio of 90:8:2;

FIG. 26 shows the SEM morphology of a LC composite comprising 5CB:RM82:NOA65 in the weight ratio of 90:2:8; and

FIG. 27 shows the SEM morphology of a LC composite comprising 5CB:RM82:NOA65 in the weight ratio of 90:8:2.

### DETAILED DESCRIPTION OF THE INVENTION

The LC composite of the invention comprises (i) a liquid crystal material, and (ii) a copolymer polymerized from LC monomers and non-LC monomers. The LC composite is mechanically stressed or sheared so that the composite may be shear aligned.

In various embodiments, the LC composite exhibits a transmittance, in the range of from about 400 nm to about 2000 nm such as 500 nm, of at least 65%, preferably at least 75, more preferably at least 85%, and most preferably at least 90%. In preferred embodiments, a SLC cell using the LC composite can have near 100% transparency in the visible spectra.

In various embodiments, the LC composite exhibits a response time in the range of from about 0.01 to about 50 milliseconds, preferably from about 0.1 to about 10 milliseconds, more preferably from about 0.1 to about 5 milliseconds, and most preferably from about 0.2 to about 4 milliseconds.

Although any liquid crystal material or mixture thereof may be used in the LC composite of the invention, in preferred embodiments, the liquid crystal material comprises a nematic liquid crystal, such as a nematic liquid crystal having birefringence greater than 0.1, preferably in the range of from 0.1 to 0.7, more preferably in the range of from 0.15 to 0.25, and most preferably in the range of from 0.18 to 0.24.

In exemplary embodiments, the nematic liquid crystal in the LC composite comprises a cyanobiphenyl eutectic mixture, such as mixtures of long aliphatic tail cyanobiphenyls, for example, those commercially known as Liquid Crystal E7 and E44.

In various embodiments, the cyanobiphenyl eutectic mixture may comprise Liquid Crystal 5CB, as shown below, together with its phase transition scheme:

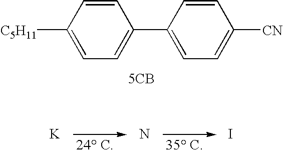

Liquid Crystal E44 is a commercial product that can be obtained from EMD Chemicals. Liquid Crystal E7 comprises a mixture of 51% (wt) of 4-Cyano 4′-pentyl biphenyl (formula A), 25% (wt) of 4-Cyano 4′-heptyl biphenyl (formula B), 16% (wt) of 4-Cyano 4′-octyloxy biphenyl (formula C), and 8% (wt) 4-Cyano 4′-pentyl triphenyl (formula D).

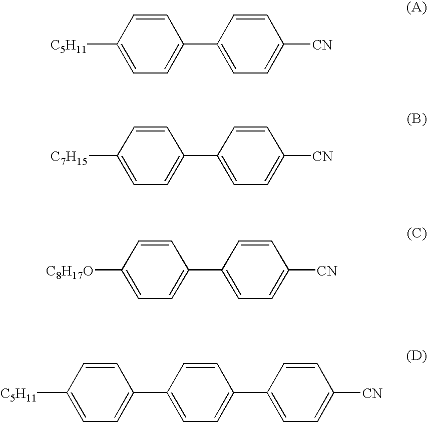

Any monomers that exhibit liquid crystal may be used as the LC monomer in the LC composite of the invention. Examples of suitable LC monomers include, but are not limited to 1,4-di(4-(6-acryloyloxyhexyloxy)benzoyloxy)-2-methylbenzene (RM82), 1,4-di(4-(3-acryloyloxypropyloxy)benzoyloxy)-2-methylbenzene, (4-(6-acryloyloxyhexyloxy)-4(hexyloxy)benzoyloxy) benzene, RM257, and the like , and any mixture thereof. RM257 is a commercial product that can be obtained from EMD Chemicals.

In various embodiments, the non-LC monomers may be monomers that can be thermally cured or photo-cured into a transparent polymer. For example, the non-LC monomer may be selected from photo-polymerizable monomers such as thiolene, mercaptan, NOA83H, NOA65, and any mixture thereof. NOA83H and NOA65 are commercial products that can be obtained from Norland Products Inc.

The weight ratio between the liquid crystal material, the LC monomer, and the non-LC monomer in the LC composite of the invention is x:y:z. The value of x may be for example from about 85 to about 92; the value of y may range for example from about 2 to about 6; and the value of z may be for example from about 15 to about 5. In a preferred embodiment, x:y:z=90:4:6.

The present invention provides a method of preparing a LC composite comprising: (i) providing a mixture comprising a liquid crystal material, LC monomers and non-LC monomers; (ii) copolymerizing the LC monomers and the non-LC monomers; and (iii) shearing the mixture with a mechanical force/stress.

The present invention also provides a LC cell comprising the LC composite as described above, and a LC device comprising such a cell. Unlike traditional PDLCs and liquid crystals cells, ultra fast response time can be gained for both thin cells (couple of microns) and thick cells (10s of microns thick).

The LC device of the invention can be selected from adaptive optics, such as a tip-tilt corrector, and from general devices, such as compact cameras, compact telescopes, and phase retarding devices. The invention can be used in any application requiring changes in the optics of a device. “Adaptive optics” refers to optical systems which adapt to compensate for optical effects introduced by the medium between the object and its image. For example, stars twinkle as a result of high altitude atmosphere turbulence. This turbulence problem in astronomy can be solved by the application of high-speed, real-time, active optical systems or adaptive optics. An example of adaptive optics is a fast tip-tilt wavefront corrector. A simple form of an adaptive optics device may be a tip-tilt corrector which can be a HTSLC/SLC based beam steering device.

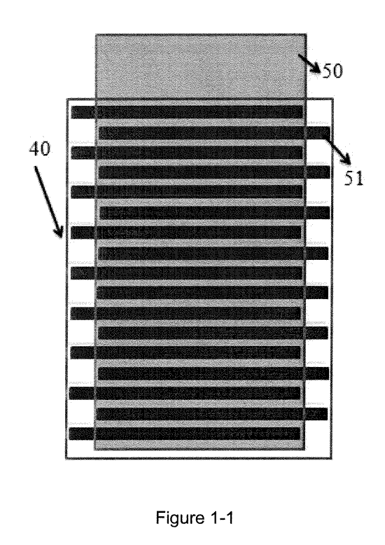

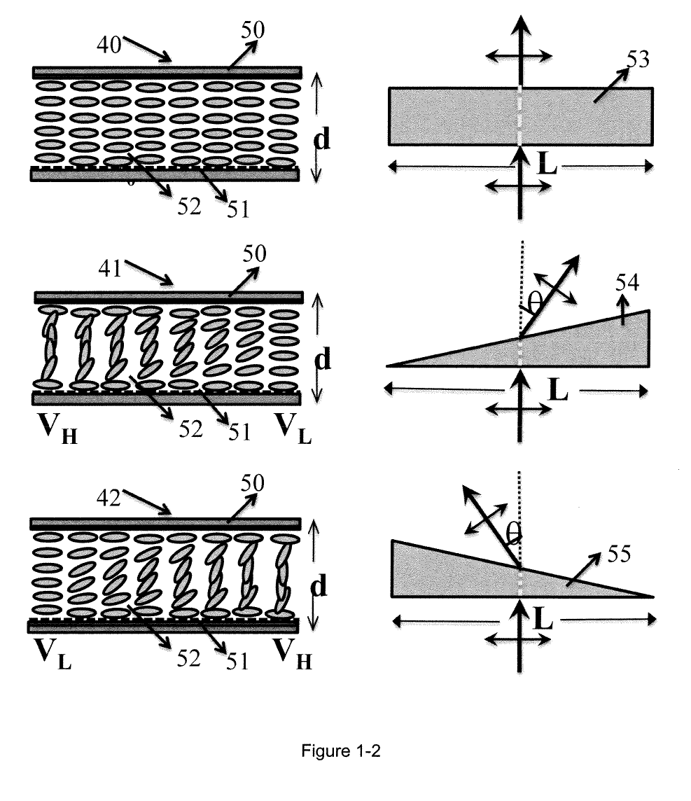

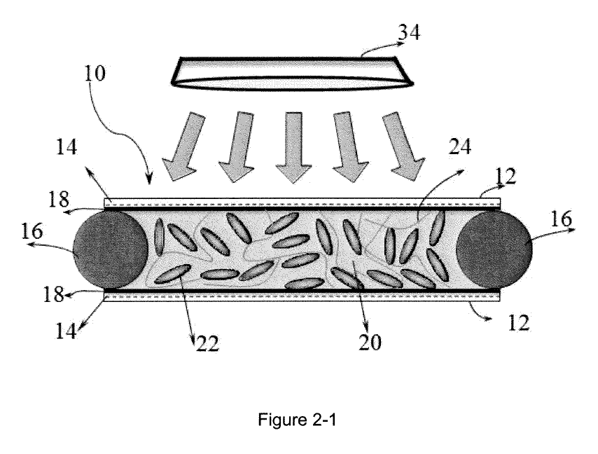

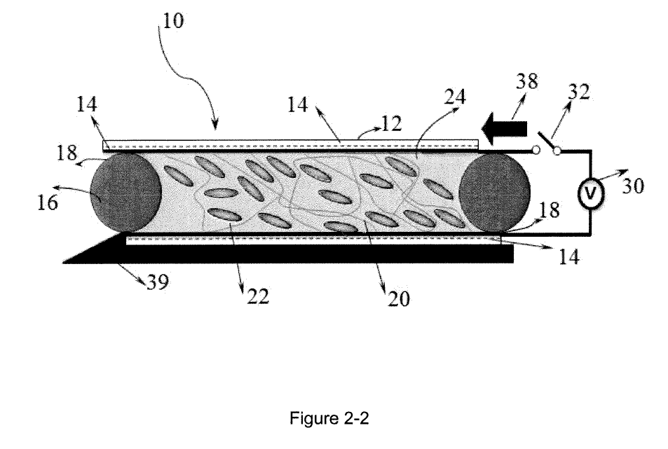

The schematic diagram of an optical HTSLC tip-tilt corrector is shown in FIG. 1-1. With reference to FIG. 1-1, one of the tip-tilt corrector substrates 51 (or bottom substrate) has interdigitally patterned ITO electrodes and the other one 50 has a uniform unpatterned ITO coating. The cell thickness can be controlled using fiber spacers outside the pixel area. LC/monomer mixture 52 (as shown in FIG. 1-2) is sandwiched between these two substrates and the HTSLC cell may be fabricated, for example, by a process as described in Example 2 in the specification. The shearing direction may be perpendicular to the stripes of the patterned electrodes. When the LC domains are aligned in the same direction, light scattering in the visible can be drastically reduced due to a match between the refractive index of the LC and the polymer and the disappearance of a mismatch of refractive index between the LC domains. Transparency is also enhanced because the LC directors inside the polymer structures are aligned along the shearing direction of the cell.

The beam-steering effect of a LC cell in various voltage driving conditions is schematically illustrated in FIG. 1-2. The left column in FIG. 1-2 shows the LC director configurations and the right column shows the corresponding optical phase profiles. In the right column, the double-head arrows indicate the beam polarization direction, and the up-arrows indicate the beam's propagation direction. With reference to the two upper panes in FIG. 1-2, when no voltage is applied to the LC device 40, the optical phase profile is parallel to the substrate 50 or 51, and the incident beam such as a laser beam does not change its propagation direction. With reference to the two middle panes in FIG. 1-2, when a linear increasing voltage is applied to the electrodes from right (V_{L}) to left (V_{H}) in device 41, the optical phase profile becomes tilted and causes the incident laser beam to steer away from its original direction to the right 54. With reference to the two lower panes in FIG. 1-2, when a linear increasing voltage profile was applied to the electrodes from left (V_{L}) to right (V_{H}) in device 42, the beam steers away from its original direction to the left 55. The steering angle was governed by the equation sinθ=Δnd/L, where Δn is the birefringence of the liquid crystal, d is the liquid crystal cell thickness (as illustrated in FIG. 1-2), and L is the width of the phase profile (as illustrated in FIG. 1-2).

The general SLC tip-tilt corrector was disclosed by Bin Wan at al in Applied Optics vol 44, No 36, 799-803 (2005), which is incorporated herein by reference in its entirety, and which may be consulted for other details of known optical HTSLC tip-tilt corrector devices. The current invention improves on this as set forth above.

The present invention provides a method of preparing a LC cell comprising: (i) providing a mixture comprising a liquid crystal material, LC monomers and non-LC monomers; (ii) copolymerizing the LC monomers and the non-LC monomers; (iii) placing the mixture between two substrates; and (iv) shearing the mixture with a mechanical force/stress. In one embodiment, the two substrates were coated with an electrically conducting and optically transparent material.

The present invention further provides a method of preparing a LC device comprising: (i) providing a mixture comprising a liquid crystal material, LC monomers and non-LC monomers; (ii) copolymerizing the LC monomers and the non-LC monomers; (iii) placing the mixture between two substrates; and (iv) shearing the mixture with a mechanical force/stress.

The invention exhibits numerous merits, such as high transmittance in visible and IR range, it is hysteresis free, it is easily fabricated, it is amenable to larger scale and efficient production, and it has application in curved spacing, among others.

### Example 1

### Preparation of LC Composites

Two samples of LC-Polymer mixture and one control sample were prepared. Two 5CB:RM82:NOA65 mixtures were made with 90:4:6 and 90:6:4 concentrations, respectively. A mixture of 5CB:NOA65 in the ratio of 90:10 with no RM82 was used as a control for purposes of comparison. The mixtures were prepared in an environment with no or a minimum of UV exposure to avoid the monomer polymerization. Each mixture sample had 90 weight percent of 5CB and the remaining 10 weight percent of the mixture comprised photopolymer alone (in the control sample) or a mixture of photopolymer and reactive monomer. The composite mixture of 5CB, RM82 and NOA65 was thoroughly mixed at room temperature on a vortex for five minutes. Table 1 summarizes the mixtures prepared and used in the present invention.

TABLE 1

| # | Sample | Composition |
|---|---|---|
| 1 | Control (SLCs) | 5CB/NOA65 = 90/10 |
| 2 | HTSLC | 5CB/RM82/NOA65 = 90/4/6 |
| 3 | HTSLC | 5CB/RM82/NOA65 = 90/6/4 |

### Example 2

### Preparation of LC cells

The mixture of 5CB/RM82/NOA65 with percent weight ratio of 90/6/4 or 90/4/6 (i.e. #2 or #3 from Example 1) was sandwiched between 18 μm spaced ITO coated glass substrates. The mixture of 5CB/NOA65 with percent weight ratio of 90/10 (i.e. #1 SLC composition from Example 1) was sandwiched between 18 μm spaced ITO coated glass substrates and was used as a control (reference) cell. No alignment layers were applied on the ITO coated glass substrates. The cells were UV cured for 30 minutes under about 30 mW/cm² unpolarized UV light at 60° C., which is a cure temperature greater than the clearing temperature of the mixture. Subsequently, a second 30-minute UV curing (low temperature polymerization) was performed at 20° C. on the mixture with the same UV intensity.

For the 18 μm devices prepared above, a shearing distance of about 100 μm produced a maximum of possible phase shift, fast switching time and high transmittance in the visible and IR spectral range. After applying the maximum possible shear to the cell, it was sealed with an epoxy or a UV adhesive to secure the shear on the cell. The cells, as observed, were highly transparent in the visible and near IR spectral range.

The mechanical shearing plays an important role in fabricating a transparent HTSLC cell. The mechanical shearing is functional in (i) matching the refractive indices of the polymer matrix and the LC, and (ii) improving the LC director alignment in the shearing direction. Both result in high transmittance and less scattering of the cell.

FIGS. 2-1, 2-2 and 2-3 illustrate the process of preparing a liquid crystal cell including a shearing step. With reference to FIG. 2-1, the HTSLC cell 10 was fabricated from two substrates 12. The substrates 12 were coated with transparent electrodes 14, usually an ITO coating. The thickness of the cell was maintained by using spacers 16. The substrates may optionally be treated with alignment layers 18. These alignment layers help the liquid crystal material to align in a specific direction. In this Example 2, no alignment layer was employed. A HTSLC material comprising a liquid crystal material, a reactive mesogen and UV-curable/heat-curable polymer/monomers was filled between the substrates 12. The liquid crystal materials could be a Nematic, Cholesteric or a Smectic. In this Example, nematic LC materials were employed. The material-filled cell was then exposed to a UV light source 34 for a time period of 20-120 minutes to polymerize the monomer/polymer, forming a polymer matrix 24 and connections between the top and bottom substrates which keep the cell bonded. The intensity of the UV light source can be in the range of 10-110 mW/cm². Used in this Example was a UV irradiation from a UV source for about 30 minutes at about 30 mW/cm². During the UV curing process, the temperature in the hot stage was maintained above the nematic-isotropic transition temperature of the liquid crystal used in the HTSLC material. The composite material 20 was then cooled down to room temperature. After polymerization, the composite material 20 exhibited separated phases, including domains or channels of the liquid crystal 22 along with a solid polymer matrix 24 sufficient to hold the substrates and the material 22 together without a need to seal the cell boundaries. The liquid crystal 22 directors were randomly oriented at this stage.

With reference to FIG. 2-2, the cell 10 was sheared using a shearing device 39 which fixed the bottom substrate 12 and prevented it from moving to the left direction. The top substrate 12 was then sheared along the direction 38, and the top substrate 12 slid parallel to the bottom substrate 12 just to align the directors of liquid crystal 22 along the shearing direction 38 with no damage to the polymer matrix 24. Since any misalignment between liquid crystal 22 domains or polymer matrix 24 can drastically reduce the transmittance of the cured material, this shearing step is crucial for the HTSLC cell 10, in that it can align the liquid crystal 22 directors and stretch the polymer matrix 24 along the shearing direction/liquid crystal director. Following the shearing step, the cell edge may be sealed to prevent movement of the substrates and the relaxation of the shear. The refractive indices of the materials used in the cell were also one of the main factors deciding the final transmittance of the device. The electrodes 14 in the cell were connected to a voltage supplier 30 with ON/OFF switch 32 in order to apply an electric field to the HTSLC material for electro optical measurements. When the switch 32 was in the OFF state, the average liquid crystal 22 director was along the shearing direction.

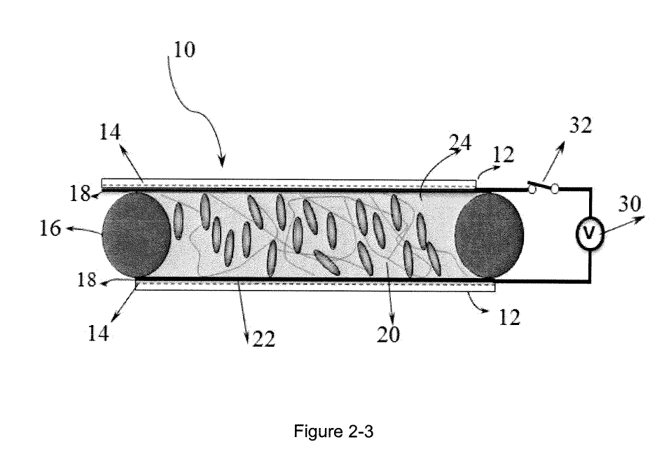

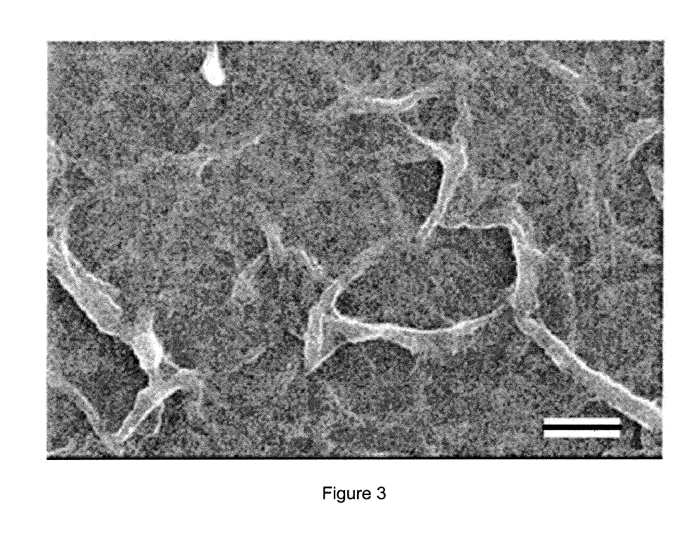

With reference to FIG. 2-3, when the switch 32 was in the ON state, the average liquid crystal 22 director was normal to the substrates 12 and along the field direction. In this Example, the LC material exhibited a positive dielectric anisotropy, causing the liquid crystal molecules to align their long axis along the electric field direction.

### Example 3

### SEM Morphologies

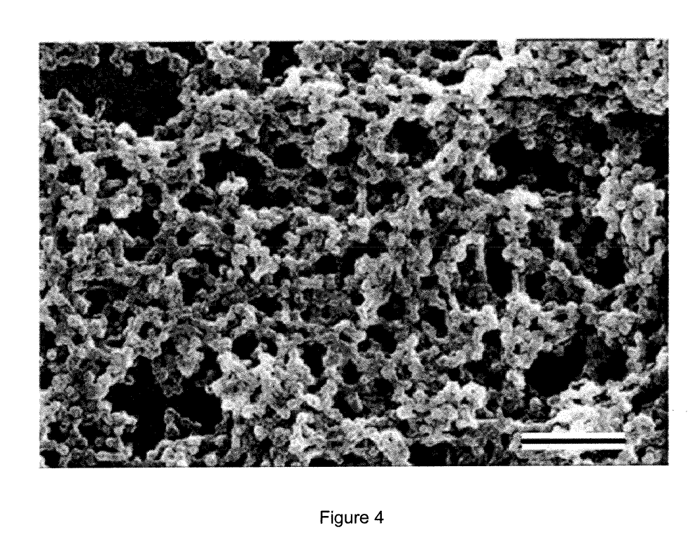

A scanning electron microscopy (SEM) was used to study the morphological details of the polymer structure. The substrates of the HTSLC cells were separated after treating the cells in liquid nitrogen. The liquid crystal material was washed out using methanol. After the evaporation of methanol, a thin layer of gold film was sputtered on the remaining polymer structures for the SEM measurements. The sputter machine was a Hummer VI-A from Anatech Ltd., and the SEM instrument was a Hitachi S2600N. The SEM morphologies of polymer structures in the HTSLC cells comprising 5CB:RM82:NOA65 in the weight ratios of 90:6:4 and 90:4:6 were obtained. The HTSLC polymer structure with the 90:6:4 ratio is shown in FIG. 3. The structures in FIG. 3 appear to be a combination of polymer walls and polymer fibers. The HTSLC polymer structure with 90:4:6 ratio is shown in FIG. 4. The structures in FIG. 4 appear to be polymer-ball-like structures. The bars located at the right-bottom corner in FIGS. 3 and 4 represent a distance of 10 μm. Despite the two different SEM morphologies, both HTSLC mixtures exhibit high transmittance of visible light.

### Example 4

### Visible and IR Transmittance

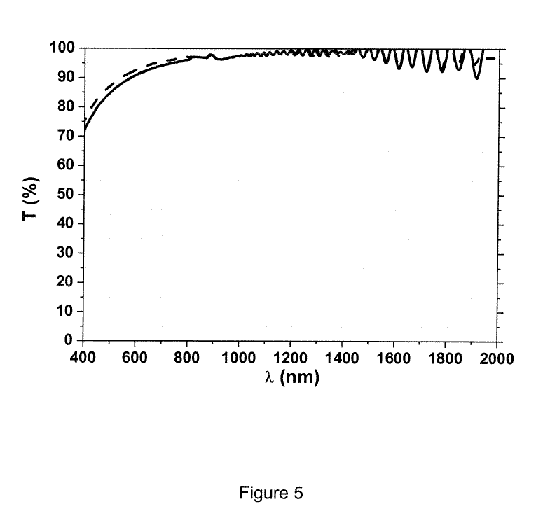

The transmittance measurement of the HTSLC cells made from Samples #1, #2 and #3 in Example 1 was taken using UV/VIS/NIR spectrometer Lambda19 from Perkin Elmer. The transmittances of the 18-μm-thick HTSLC cells with the 5CB/RM82/NOA65 ratio of 90/6/4, 90/4/6, and 90/0/10 (reference cell) are demonstrated in FIGS. 5, 6 and 7, respectively. The reference used to correct reflection loss was a fully-cured 18-μm-thick NOA65 film sandwiched between two ITO coated glasses. With reference to FIG. 5, 6 or 7, two percent-transmittance (T %) curves, one of which is solid and another one dashed, represent the transmittances for polarized light at two polarizations, one of which is parallel or horizontal to the liquid crystal cell shear direction, and another perpendicular or vertical to the liquid crystal cell shear direction.

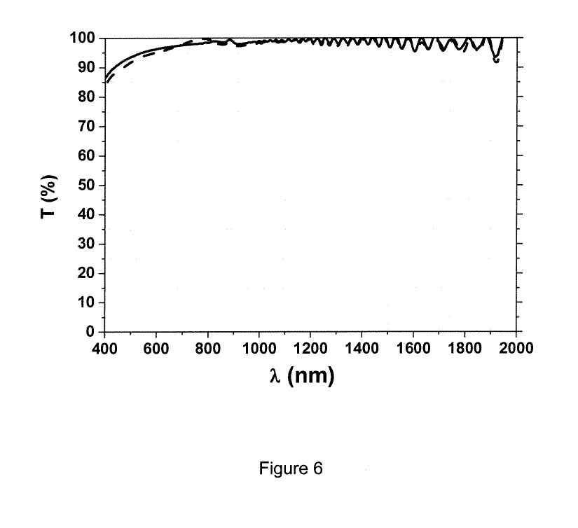

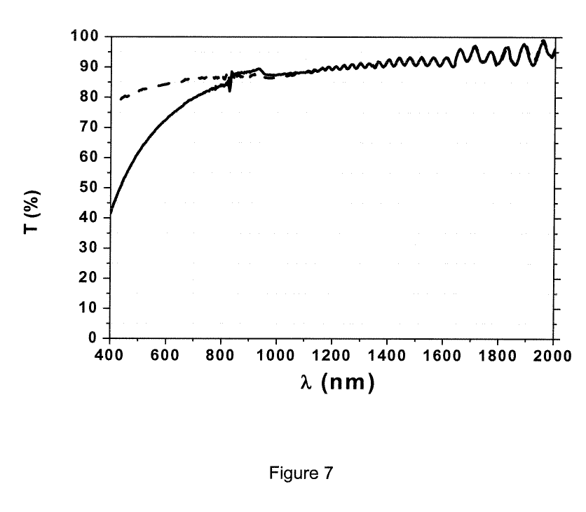

As observed from FIGS. 5 and 6, the transmittance of a sheared HTSLC cell is essentially independent of the polarization of light, in contrast to the transmittance of a sheared SLC cell in FIG. 7.

Table 2 shows the transmittance for the 18 μm HTSLC cells comprising different amounts of RM82 in the 400-800 nm visible range in a 100 nm interval. A significant improvement of transmittance can be observed from about 55% (5CB/NOA65 mixture, the SLC formulation) to above ˜90% (with 4% or 6% of RM) at 600 nm wavelength.

TABLE 2

| Composition | % Transmittance | | | | |
|---|---|---|---|---|---|
| 5CB:RM82:NOA65 | 400 nm | 500 nm | 600 nm | 700 nm | 800 nm |
| 90:4:6 | 85 | 94 | 96 | 98 | 98 |
| 90:6:4 | 74 | 86 | 92 | 95 | 97 |

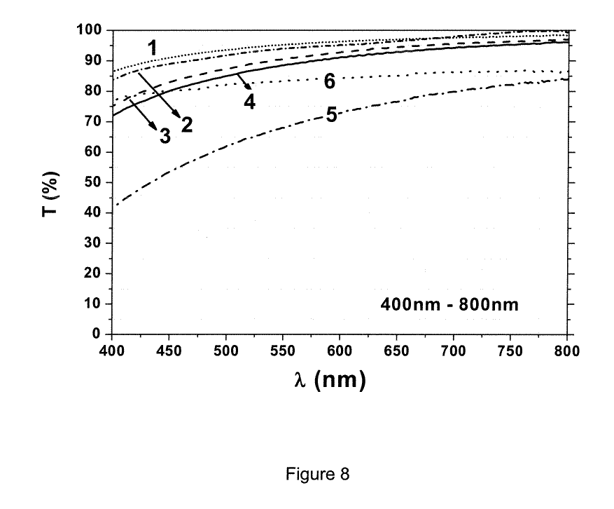

FIG. 8 shows the transmittances of the 18 μm thick sheared cells containing the mixtures of 5CB:RM82:NOA65 (90:6:4 and 90:4:6) along with the mixture of 5CB:NOA65 (90:10) in the 400-800 nm visible range. With reference to FIG. 8, curves 1 and 2 represent the transmittances of the 90:4:6 mixture with shearing being parallel and perpendicular to the polarized light beam respectively; curves 3 and 4 represent the transmittances of the 90:6:4 mixture with shearing being parallel and perpendicular to the polarized light beam respectively; and curves 5 and 6 represent the transmittances of the 90:10 mixture with shearing being parallel and perpendicular to the polarized light beam respectively.

### Example 5

### Electro-Optical measurements

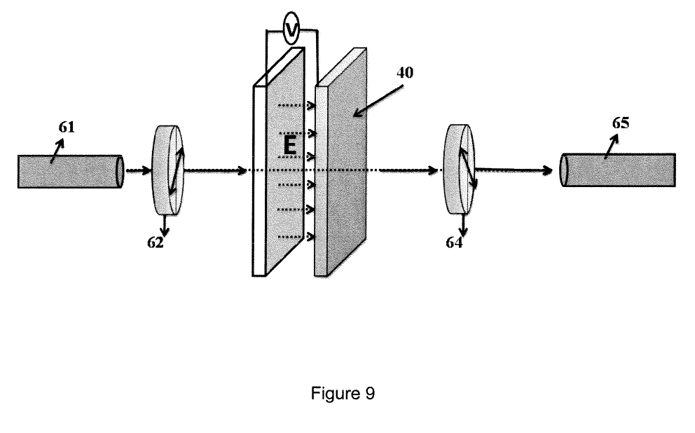

The setup for the measurement of electro-optical properties such as time response and static response is shown in FIG. 9. The measurements were carried out by the “Electro Optical Measurement” software developed by Boslab, Liquid Crystal Institute at Kent State University. Square waveforms were generated using National Instruments data acquisition (DAQ) card PCI-6071E. This DAQ card was also used for detector data acquisition and variable gain amplifier control. The voltage limit was increased by an external amplifier 7602M from Krohn-Hite Corporation. The voltage amplitude was monitored using TDS210 from Tektronix. With reference to FIG. 9, the laser wavelength from the source 61 was 0.6328 μm and a photo detector 65 was connected to the DAQ card (not shown). Electro-optical measurements of a HTSLC/SLC device 40 were taken by placing it in between a crossed polarizer 62 and an analyzer 64, with shearing direction of the cell aligned at 45° with respect to the polarizer 62 and the analyzer 64.

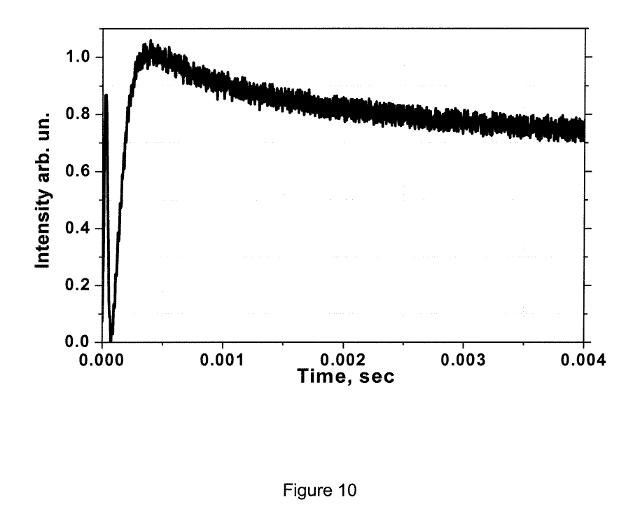

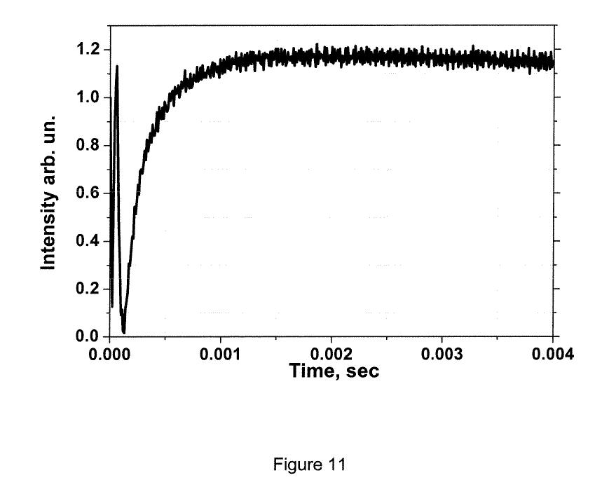

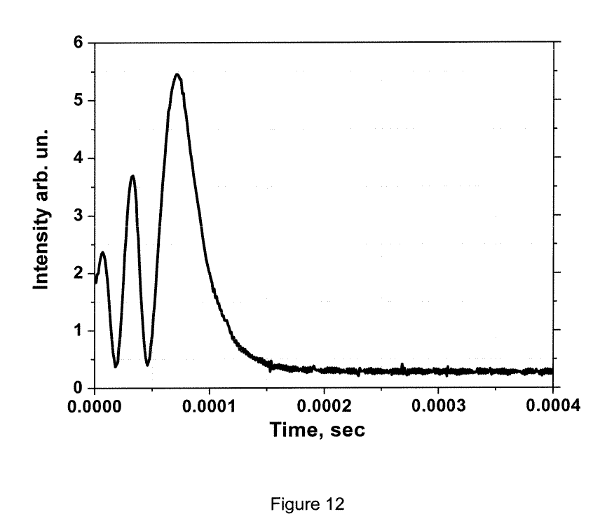

FIG. 10 and FIG. 11 show the time responses of the 18 μm liquid crystal cells comprising 5CB:RM82:NOA65 in the weight ratio of 90:6:4 and 90:4:6. FIG. 12 shows the time responses of the 18 μm liquid crystal cell comprising 5CB:NOA65 in the weight ratio of 90:10 as a control.

Turn-on time (T_{ON}) in milliseconds of the 18 μm LC composite cells is given in Table 3. The electro-optical set up of the measurement is shown in FIG. 9. The simplest Turn-on time Response Measurement can use a square wave from a waveform driver which switches from low voltage (e.g. 0V) to high voltage (e.g. 80V). When the waveform driver switches the output from state 0V to state 80V, a detector driver starts collecting brightness data. The collected brightness vs. time data was used to determine T_{ON}.

TABLE 3

| Composition | |
|---|---|
| Cell thickness: 18 μm | T_{ON}(ms) |
| 5CB:RM82:NOA65 = 90:4:6 | 1 |
| 5CB:RM82:NOA65 = 90:6:4 | 1 |

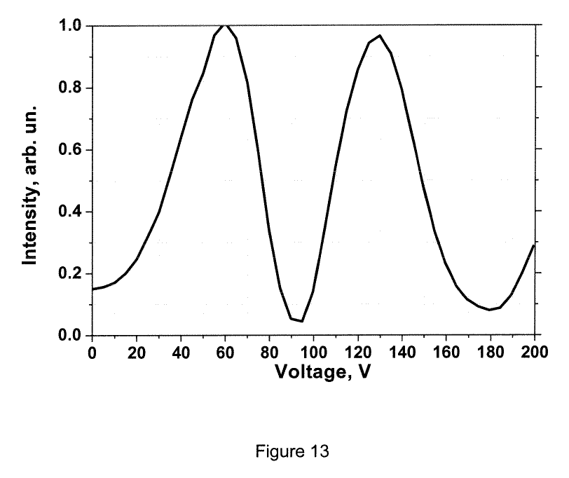

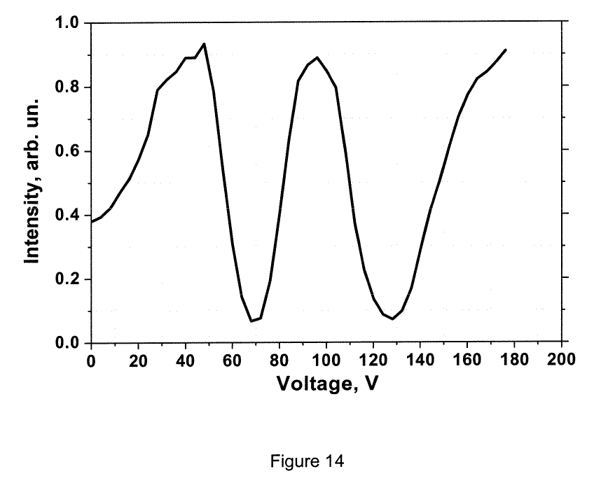

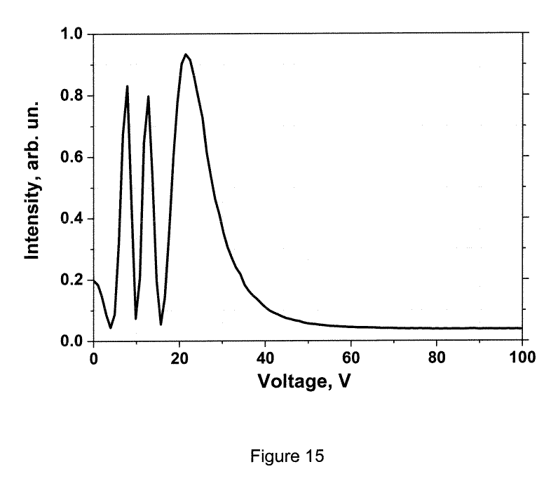

FIGS. 13-14 show the static responses of the 18 μm liquid crystal cells comprising 5CB:RM82:NOA65 in the weight ratio of 90:6:4 and 90:4:6. FIG. 15 shows the static responses of the 18 μm liquid crystal cells comprising 5CB:NOA65 in the weight ratio of 90:10 as a control.

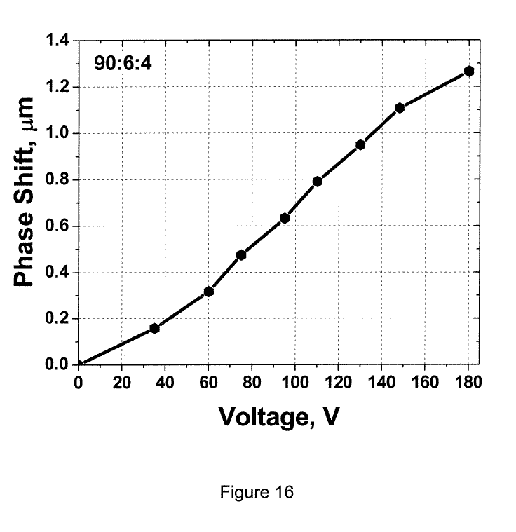

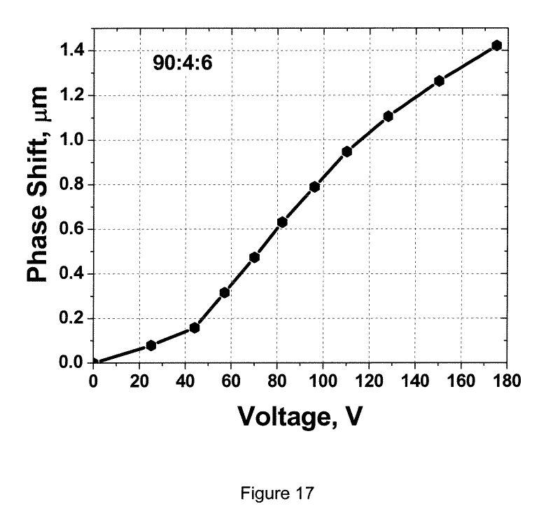

FIGS. 16 and 17 demonstrate the phase retardation-voltage relation for the two HTSLC 18 μm thick cells comprising 5CB:RM82:NOA65 in the weight ratio of 90:6:4 and 90:4:6.

### Example 6

### Wave Number (Optical Phase Delay: Δnd)

At a particular wavelength (λ=632.8 nm), a continuous voltage sweep was applied to the liquid crystal cell prepared in Example 2 to measure the switching fields using the crossed polarizer set up as shown in FIG. 9. The transmittance intensity is given by

$$l = {l}_{max} \cdot {sin}^{2} ( \frac{Δ nd}{λ} ) .$$

Iₘₐₓ represents the maximum intensity of the static response curve. Depending on

$$( \frac{Δ nd}{λ} )$$

being equal to k/2 or (k+1)/2 (where k is an odd integer), the maximum or minimum intensities can be obtained respectively. The optical path delay between two side-by-side maxima or minima is a λ. From the transmittance intensity 1, the optical phase delay can be calculated using,

$$Δ nd = m λ \pm \frac{λ}{π} \cdot a sin \sqrt{I / {I}_{max}}$$

As shown in Table 4, in order to get more than 2 waves (Δnd/λ), 18 μm HTSLC (5CB/NOA65=90/10) cell was needed.

TABLE 4

| | Composition | |
|---|---|---|
| Cell # | [Cell thickness: 18 μm] | Δnd/λ |
| 1 | 5CB:NOA65 = 90:10 | 3.1 |
| 2 | 5CB:RM82:NOA65 = 90:4:6 | >2.3 |
| 3 | 5CB:RM82:NOA65 = 90:6:4 | >2.2 |

### Example 7

### Retardation Efficiency

FIGS. 16 and 17 show the dependence of the phase retardation as a function of voltage for sheared 18 μm cells. The variation of the transmitted light intensity between two successive minima or maxima demonstrates the switch of the phase retardation equal to the wavelength of the source light 0.6328 μm. The phase shift of the device initially increases linearly with shear and then asymptotically approaches a maximum value at large shear. In order to produce higher phase retardation, the shearing should be optimized to create a uniaxial liquid crystal alignment and thus greatly reduce light scattering. Above a certain shear, the glass substrates separate and the cell may be destroyed. The expected maximum phase retardation is Δnd (1−c)=3.1 μm, where Δn is the birefringence of 5CB which is 0.191; d is the cell thickness 18 μm; and c is the polymer concentration 0.1. If it is determined that the efficiency of the phase retardation is the ratio of the expected or theoretical maximum shift of the phase retardation to the experimental value, it can be stated that both HTSLC cells of 18 μm thickness have an efficiency of the phase separation of minimum 40% (more than 1.42 μm phase retardation), while the SLC (90:10) cell of the same thickness has 48% (1.64 μm phase retardation) efficiency of phase separation. The total efficiency of the phase separation could not be measured for the HTSLC cells, given that the cell requires higher voltages to observe the complete phase retardation profile than a cell of this mixture can withstand, but such high voltages could destroy the cell.

Without the intension to be bound by any particular theory, it is believed that the reason for the transmittance improvement (or scattering reduction) might be attributed to the smaller domain size, stronger anchoring between the polymer and the liquid crystal, and the close match of the refractive indices of the chosen materials. The refractive indices for the materials used in the present cells are given in Table 5.

TABLE 5

| Material | n₀ | nₑ | n |
|---|---|---|---|
| RM82 | 1.532 | 1.656 | — |
| 5CB | 1.533 | 1.724 | — |

| | | |
|---|---|---|
| NOA65 | — | 1.524 |

### Example 8

### Two LC Composites

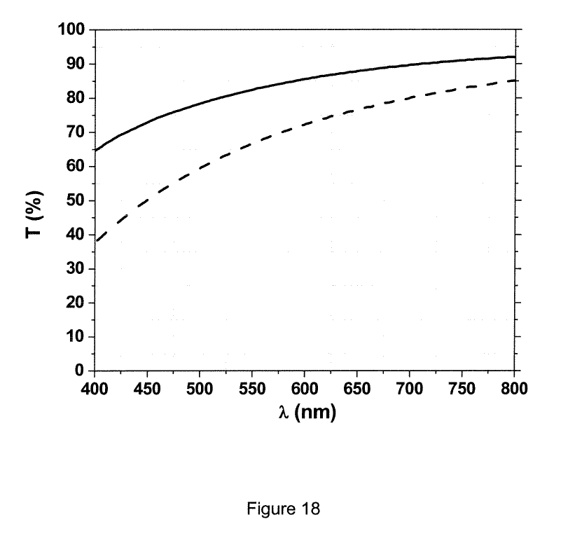

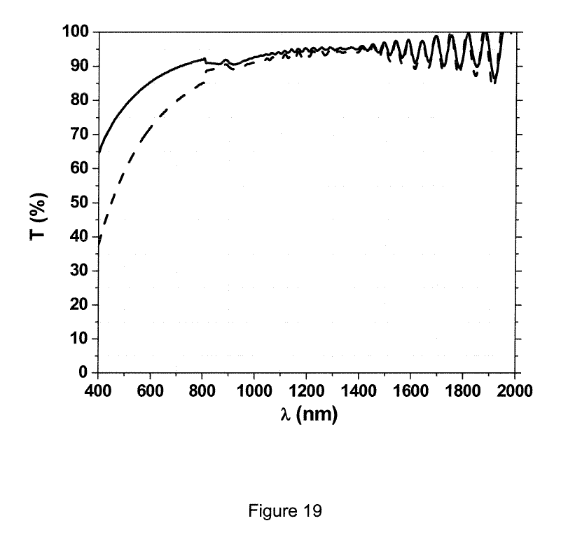

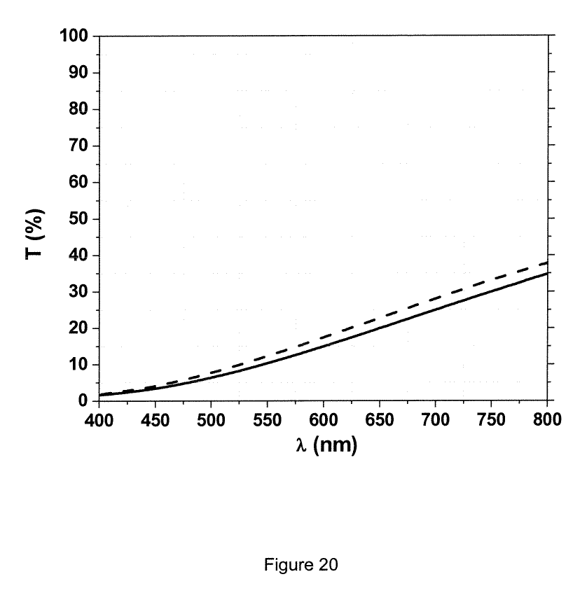

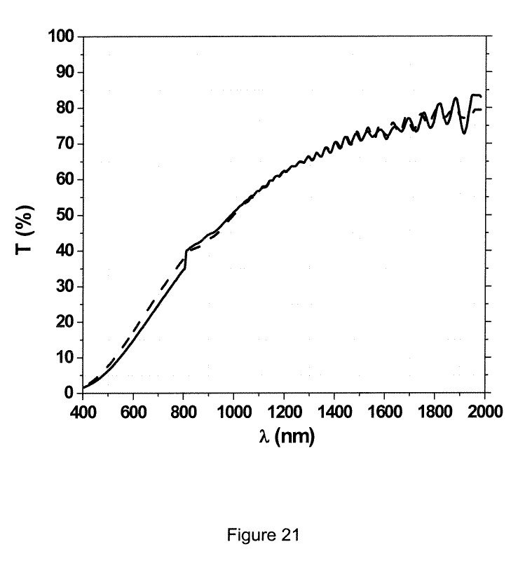

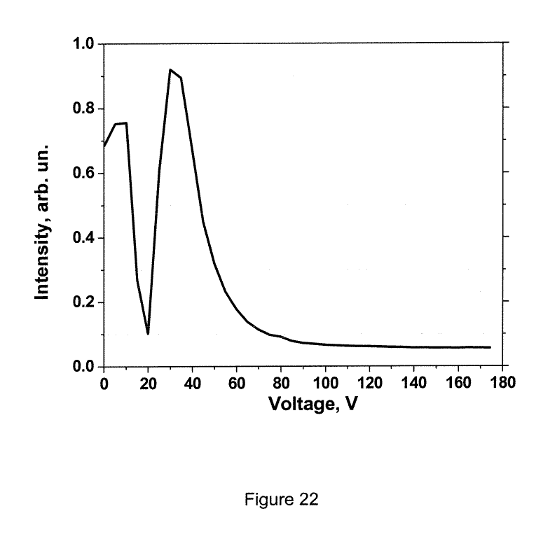

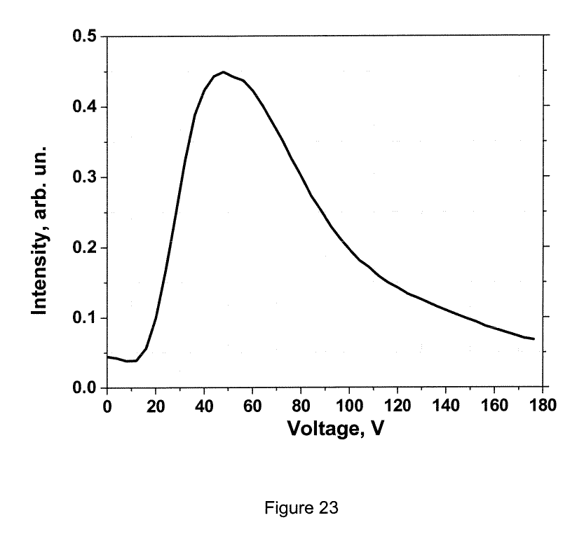

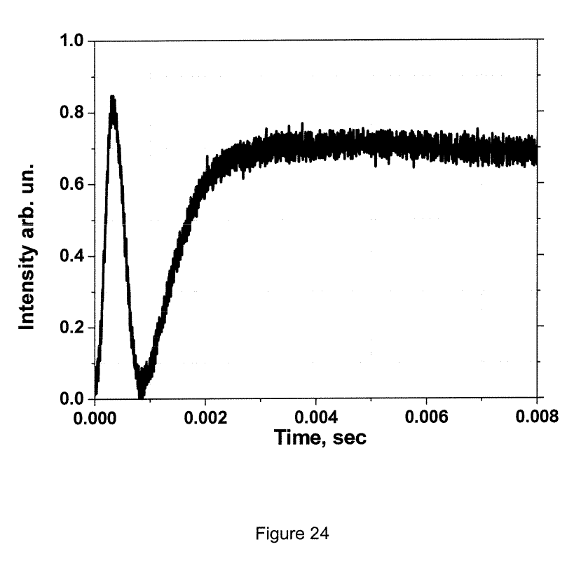

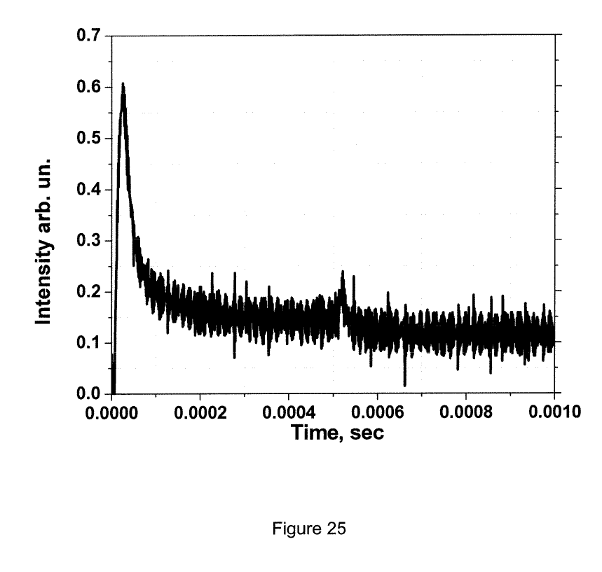

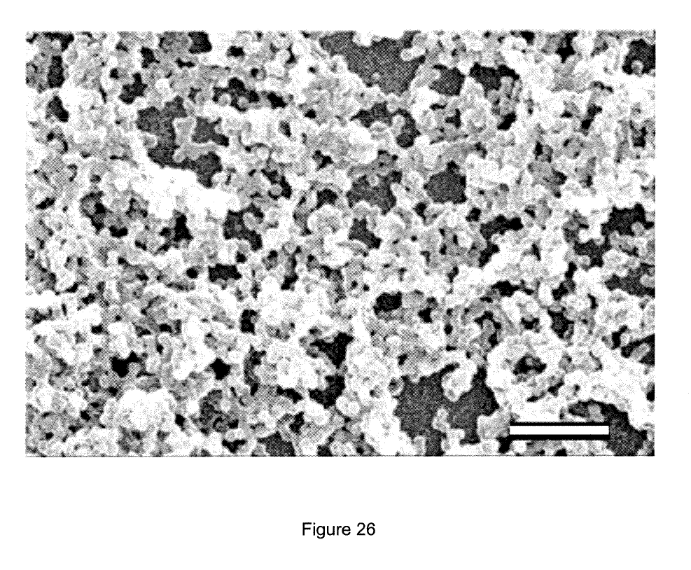

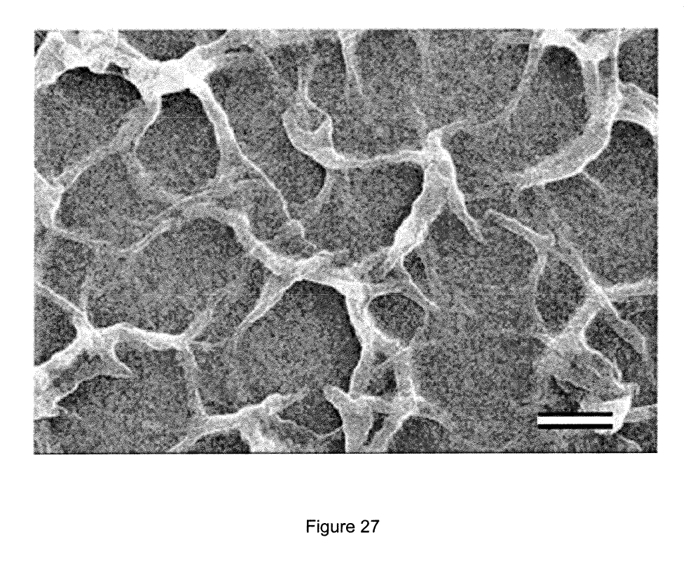

Similar to Examples 1-7, two more LC composites comprising 5CB:RM82:NOA65 in the weight ratios of 90:2:8 and 90:8:2 (hereinafter “90:2:8 sample” and “90:8:2 sample”) were prepared and tested, and the results are shown in FIGS. 18-27. The data of FIGS. 18-25 were all obtained using 18 μm high transmittance liquid crystal cells, as described above. The transmittance spectra of the two samples in 400-800 nm range are reproduced in FIGS. 18 and 20, and that in 400-2000 nm range in FIGS. 19 and 21. FIGS. 22-25 show the static responses and the time responses of the two samples. FIG. 26 shows the SEM morphology of the 90:2:8 sample, and FIG. 27 shows that of the 90:8:2 sample.

The invention improves the transmittance and decreases the light scattering in SLC material by improving polymer structure and enhancing the properties of (i) LC alignment within each domain, (ii) orientation correlation among domains, and (iii) index matching between LC and polymer matrices.

Without the intension to be bound by any particular theory, it is believed that the domain size plays an important role in PDLC scattering. SLCs can have polymer-ball-like structures or polymer-sheet-like structures (e.g. 90/10 SLC). From the SEM images of RM82 modified SLCs, the sample with the lowest scattering (90/4/6) was observed to have a clear polymer-ball like network structure. RM82 transforms the diffusive polymer structure (instead of sheet) into an interconnected network, which might improve the polymer flexibility, thus improving the LC alignment during the shearing process of SLC cell. A significant drop down of the efficiency can also be attributed to the smaller domain size. As the RM concentration increases, the domain size of RM modified SLCs decreases.

Without the intension to be bound by any particular theory, it is believed that the use of a stretched polymer may result in more elongated domain structures, helping to increase the LC orientation order. Stretched polymers may also improve the correlation among the domains. The reactive mesogen contributes to improve the LC alignment at the LC-Polymer interface due to their liquid crystalline structure. Overall, the transmittance of SLC mixture can be optimized using a stretched polymer, correlated domains and LC alignment.

The exemplary embodiments have been described with reference to the preferred embodiments. Obvious modifications and alterations will occur to others upon reading and understanding the preceding detailed description. It is intended that the exemplary embodiment be construed as including all such modifications and alterations insofar as they come within the scope of the appended claims or the equivalents thereof.

1. A liquid crystal composite comprising (i) a liquid crystal material, and (ii) a copolymer polymerized from liquid crystal monomers and non-liquid crystal monomers; wherein the liquid crystal composite is mechanically stressed/sheared.

2. The liquid crystal composite according to claim 1, which is shear aligned to produce a transmittance of at least 65% in the range of from about 400 nm to about 2000 nm.

3. The liquid crystal composite according to claim 1, which exhibits a response time in the range of from about 1 to about 10 milliseconds.

4. The liquid crystal composite according to claim 1, in which the liquid crystal material comprises a nematic liquid crystal.

5. The liquid crystal composite according to claim 4, in which the nematic liquid crystal has birefringence greater than 0.1.

6. The liquid crystal composite according to claim 5, in which the nematic liquid crystal comprises a cyanobiphenyl eutectic mixture.

7. (canceled)

8. The liquid crystal composite according to claim 6, in which the cyanobiphenyl eutectic mixture comprises 4-cyano 4′-pentyl biphenyl.

9. The liquid crystal composite according to claim 1, in which the liquid crystal monomer is selected from 1,4-di(4-(6-acryloyloxyhexyloxy)benzoyloxy)-2-methylbenzene, 1,4-di(4-(3-acryloyloxypropyloxy)benzoyloxy)-2-methylbenzene, (4-(6-acryloyloxyhexyloxy)-4(hexyloxy)benzoyloxy) benzene, and any mixture thereof.

10. The liquid crystal composite according to claim 1, in which the non-LC monomers are monomers that can be thermally cured or photo-cured into a transparent polymer.

11. The liquid crystal composite according to claim 1, in which the non-liquid crystal monomer is selected from photo-polymerizable monomers.

12. The liquid crystal composite according to claim 1, in which the weight ratio between the liquid crystal material, the liquid crystal monomer, and the non-liquid crystal monomer is x:y:z; wherein the value of x is from about 85 to about 92, the value of y is from about 2 to about 6, and the value of z is from about 15 to about 5.

13. The liquid crystal composite according to claim 12, in which the x:y:z ratio ranges from 90:4:6 to 90:6:4.

14. A liquid crystal cell comprising the composite according to claim 1.

15. A liquid crystal device comprising the cell according to claim 14.

16. The liquid crystal device according to claim 15, which is selected from adaptive optics, compact cameras, compact telescopes, phase retarding devices, IR beam steering devices, fast tip-tilt wavefront correctors, high tech widows, and special glass cells.

17. A method of preparing a liquid crystal composite comprising: (i) providing a mixture comprising a liquid crystal material, liquid crystal monomers and non-liquid crystal monomers; (ii) copolymerizing the liquid crystal monomers and the non-liquid crystal monomers; and (iii) shearing the mixture with a mechanical force/stress.

18. A method of preparing a liquid crystal cell comprising (i) providing a mixture comprising a liquid crystal material, liquid crystal monomers and non-liquid crystal monomers; (ii) copolymerizing the liquid crystal monomers and the non-liquid crystal monomers; (iii) placing the mixture between two substrates; and (iv) shearing the mixture with a mechanical force/stress.

19. The method according to claim 18, in which the two substrates are substrates coated with electrically conducting and optically transparent material.

20. A method of preparing a liquid crystal device comprising (i) providing a mixture comprising a liquid crystal material, liquid crystal monomers and non-liquid crystal monomers; (ii) copolymerizing the liquid crystal monomers and the non-liquid crystal monomers; (iii) placing the mixture between two substrates; (iv) shearing the mixture with a mechanical force/stress; and (v) including the substrates having mixture between the two substrates in the device.
